(19) United States
(12) Patent Application Publication
(10) Pub. No.: US 2008/0298345 A1
(43) Pub. Date: Dec. 4, 2008

(54) Cross-connect for emulated circuit-base communications

(76) Inventors: Llija Hadzic, Millington, NJ (US); Edward S. Szurkowski, Morristown, NJ (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/807,668

(22) Filed: May 30, 2007

(51) Int. Cl. H04L 12/66

(52) U.S. Cl. 370/352

(57) ABSTRACT

In one embodiment, a software-based cross-connect routes packets in an asynchronous Ethernet packet network to emulate circuit-based switching in a conventional circuit-oriented synchronous TDM network. The cross-connect has Ethernet interfaces for receiving and storing incoming Ethernet packets transmitted over the packet network from various source nodes. A cross-connect processor manipulates the stored Ethernet packets based on a stored connection table that defines emulated circuit-based connections in order to generate and store outgoing Ethernet packets in appropriate interfaces that then transmit the outgoing Ethernet packets via the packet network towards their defined destination nodes.

### BACKGROUND OF THE INVENTION

1. Field of the Invention

The invention relates to communications networks, and, in particular, to packet-based communications networks conforming to an Ethernet standard.

2. Description of the Related Art

FIG. 1 shows a high-level block diagram of a conventional circuit-oriented communications network 100 relying on synchronous, time-division multiplexed (TDM) transport media (i.e., T1 and T3 links). In particular, FIG. 1 shows five end nodes (i.e., customers 110-130, public switched telephone network (PSTN) 140, and Internet 150) interconnected via digital access and cross-connect system (DACS) 160. Each end node transmits synchronous circuit-oriented TDM signals via an appropriate link (e.g., T1 or T3) to DACS 160.

Each of customers 110-130 has a local voice-based network (e.g., PBX 114 of customer 110) and a local data-based network (e.g., LAN 116 of customer 110). Within each customer, a TDM integrated access device (IAD) (e.g., TDM IAD 118 of customer 110) functions as a mux/demux to interconnect the DS0 voice channels of the local voice-based network and the DS0 data channels of the local data-based network with the corresponding T1 link (e.g., T1 112 for customer 110). Similarly, 5E switch 144 interconnects PSTN 140 with T3 142, and router 154 (having a frame relay line card) interconnects Internet 150 with T1 152. Note that router 154 converts between the circuit-based signals of T1 152 and the packet-based signals of Internet 150.

Each T1 link supports up to 24 DS0 channels, while T3 142 supports up to 672 DS0s, where each DS0 is assigned to support communications between a particular pair of end nodes. For example, as indicated in FIG. 1, for customer 110, T1 112 has 12 DS0s assigned for voice communications for PBX 114 and 4 DS0s assigned for data communications for LAN 116. Similarly, for customer 120, T1 122 has 12 DS0s assigned for voice communications for PBX 124 and 12 DS0s assigned for data communications for LAN 126. Lastly, for customer 130, T1 132 has 16 DS0s assigned for voice communications for PBX 134 and 8 DS0s assigned for data communications for LAN 136. In FIG. 1, 4 voice DS0s in T1 112 and 4 voice DS0s in T1 132 support voice communications between customer 110 and customer 130. The rest of the voice DS0s in T1s 112, 122, and 132 support voice communications with PSTN 140, while all of the data DS0s in T1s 112, 122, and 132 support data communications with Internet 150.

DACS 160 is a TDM cross-connect device that allows DS0s from each of the connected T1/T3 lines to be extracted and remultiplexed onto other attached facilities. For example, DACS 160 allows DS0s carrying voice channels to be extracted from T1 lines 112, 122, and 132 connected to customers 110, 120, and 130, respectively. These DS0s can be remultiplexed onto a single larger facility (i.e., T3 142) going to 5E switch 144 for transmission to PSTN 140. Similarly, DS0s carrying data from the same T1 access lines can be extracted and remuxed onto T1 link 152 to router 154 for packetization and transmission to Internet 150. DACS 160 can also route DS0 voice channels from PSTN 140 and DS0 data channels from Internet 150 to appropriate customers. DACS 160 can also route DS0 voice and/or data channels from one customer to another customer. This process of manipulating channels between multiplexed links/facilities is often called grooming.

To support these various voice and data communications, the switch fabric of DACS 160 is configured with circuit-based connections to route incoming DS0s to appropriate outgoing DS0s. FIG. 2 shows one possible set of connections to support the communications of FIG. 1. For example, in T1 112 for customer 110, DACS 160 is configured to connect DS0 channels 1-8 to DS0 channels 1-8 of T3 142 for PSTN 140, DS0 channels 9-12 to DS0 channels 13-16 of T1 132 for customer 130, and DS0 channels 13-16 to DS0 channels 1-4 of T1 152 for Internet 150, while DS0 channels 17-24 are currently unassigned. As indicated in FIG. 2, DACS 160 is also configured to appropriately connect the DS0s in T1s 122 and 132.

When data is the dominant traffic type, packet-based networks, such as those conforming to an Ethernet standard, are usually less expensive to install and operate than traditional synchronous circuit-oriented TDM networks, such as network 100 of FIG. 1, that were designed and optimized for voice transport and switching. As such, carriers are beginning to deploy Ethernet networks in metropolitan areas to reduce their costs for transport and switching of data. Such networks are currently used to provide data access from end-user enterprise locations (e.g., the customers of FIG. 1) to points-of-presence for wide area networks (WAN POPs) or to provide private-line data services between pairs of enterprise sites. Ethernet is currently the most-common and lowest-cost interface for data equipment and is used in the vast majority of enterprise networks. Enterprises can connect directly to the Ethernet networks provided by carriers using a minimum of additional equipment and no format translation.

As indicated in FIG. 1, however, most enterprise locations require both voice and data metro network services from carriers. Metro voice transport services enable enterprise PBXs to access the PSTN. Data services enable enterprise LANs to access public data networks such as the Internet, and to access private internal corporate networks.

In another application, wireless base stations interface to the backhaul network using T1 or E1 connections. A wireless operator typically leases T1 or E1 lines from a wireline operator and grooms the connections from all of its base stations in the region into an RNC (Radio Network Controller) site. At the RNC site, all T1/E1 lines are terminated on a DACS where switching occurs; some connections leave the RNC site towards the external network, while some connections may be routed back to the base stations in the region.

### SUMMARY OF THE INVENTION

Problems in the prior art are addressed in accordance with the principles of the invention by a low-cost metro Ethernet infrastructure that effectively transports voice, where a single metro Ethernet connection to an enterprise site provides both voice and data services at lower total cost as compared to separate metro voice and data networks and their connections.

In one embodiment, the invention is a cross-connect for a packet-based network comprising more than two end nodes. The cross-connect comprises at least one interface and a processor. The at least one interface receives incoming packets transmitted from one or more source nodes via the packet-based network to the cross-connect, each incoming frame containing a plurality of frames of emulated circuit-based payload data, each frame destined for a destination node. The processor extracts the frames from the incoming packets and generates outgoing packets for transmission from the cross-connect via the packet-based network to one or more destination nodes, each outgoing packet containing a plurality of frames of emulated circuit-based payload data destined for a destination node.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements.

FIG. 1 shows a high-level block diagram of a conventional circuit-oriented communications network relying on synchronous, time-division multiplexed (TDM) transport media (i.e., T1 and T3 links);

FIG. 2 shows one possible set of connections to support the communications of FIG. 1;

FIG. 3 shows a high-level block diagram of an exemplary, hybrid, packet-oriented communications network using circuit emulation on Ethernet transport media, according to one embodiment of the present invention;

FIG. 4 shows a high-level block diagram of the SoftDACS of FIG. 3;

FIG. 5 shows an exemplary connection table stored in the memory of FIG. 4 and accessed by the processor of FIG. 4 to convert incoming Ethernet packets into outgoing Ethernet packets; and

FIG. 6 represents the copying of DS0 slot contents from incoming packet buffers in interface memories to particular locations in outgoing packet buffers in appropriate interface memories, as performed by the processor of FIG. 4.

### DETAILED DESCRIPTION

There has been much work in recent years focused on transmitting voice over data networks. The best known approach is voice-over-IP (VoIP). With this technology, individual digitized 64-Kbps voice streams are packetized (perhaps after compression) for transmission over a data network. A VoIP packet usually contains data from only one voice channel or call, and each packet is independently addressed and switched through the network. If a T1/E1 interface is used to connect to a VoIP gateway, the gateway extracts the bit stream corresponding to the voice samples and packetizes it (with possible signal conditioning and compression) for transport over an IP network. In other words, a VoIP gateway fully terminates the T1 interface and treats the incoming T1 payload as digitized voice samples.

An alternative approach, called circuit emulation service (CES—e.g., TDM-over-IP, TDM-over-Ethernet), transparently tunnels the TDM interface (e.g., T1/E1, T3/E3, SONET/SDH) over a packet network. It does not interpret or modify the interface payload or make any assumptions about whether the payload is voice or something else. One variant of CES, called structure-agnostic or unstructured CES, transports entire frames from a multiplexed TDM line across a data network. The bits on the TDM line are carried without alteration or interpretation over a single packet flow between source and destination. Another variant of CES, called structure-aware or structured CES, treats the TDM link on DS0 (individual time slots) granularity and may create multiple packet flows from a single TDM interface (each packet flow carrying a subset of its constituent DS0 slots), terminate multiple packet flows, and compose an interface payload out of said packets. Additional information about circuit emulation can be found in Metro Ethernet Forum's Implementation Agreement number 8 (also known as MEF8 specification), which is incorporated herein as a reference.

Circuit emulation can also transport any non-circuit traffic that might be embedded within a TDM facility. An example is the facility data link (FDL), an overhead channel that is provided in the T1 extended superframe (ESF). Because of its transparency properties, circuit emulation also supports applications that use TDM facilities to carry traffic other than voice, e.g., frame relay, videoconferencing, etc. Such applications pack their traffic into the TDM framing structures, and require that the transmission preserve both the exact bit stream and the strict time relationship between the DS0 channels.

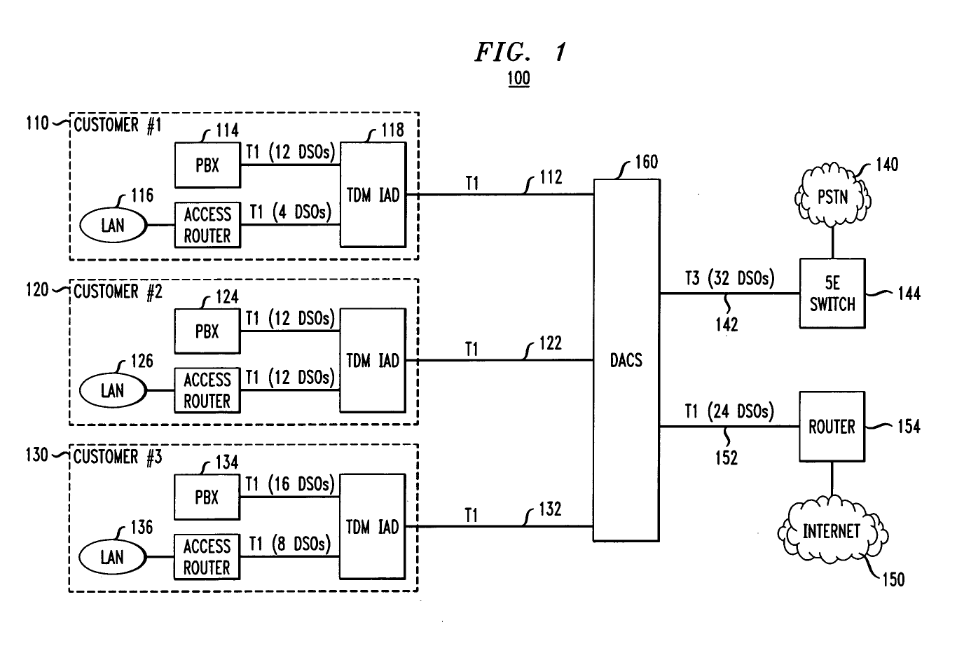

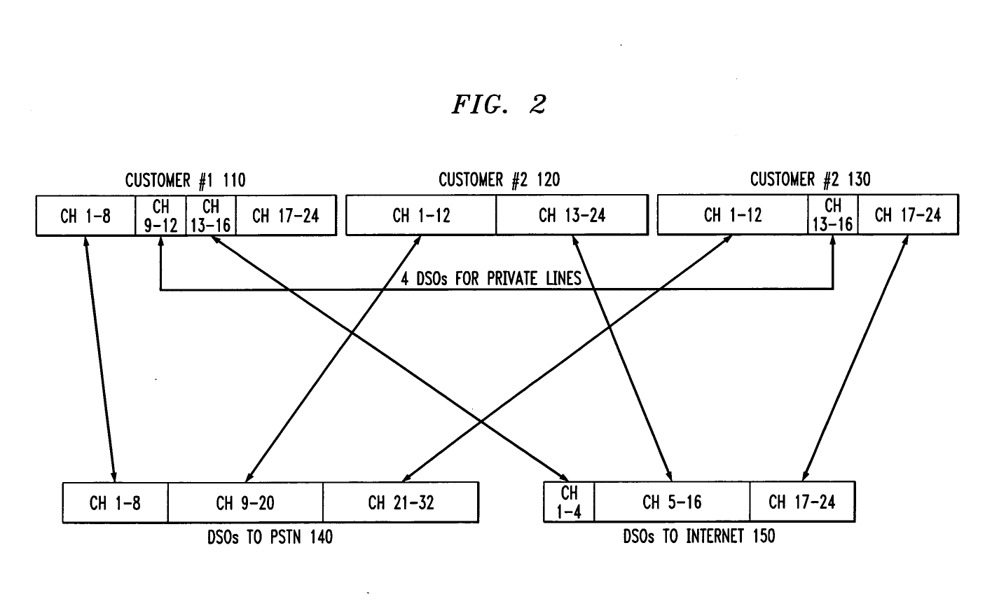

A key challenge in circuit emulation is synchronization of sampling and transmission clocks at each end of the emulated facility. Clock synchronization minimizes data loss due to small but inevitable frequency mismatches between independent clocks in the source and destination of a digital stream. Terminal devices, such as the PBXs of FIG. 1, typically synchronize their local internal TDM clocks to the PSTN global clock. The timing of a T1/E1 access line is locked to the PSTN (e.g., via DACS 160 of FIG. 1). The PBX then synchronizes its local clocks to the timing derived from this line.

To avoid data loss, circuit emulation must preserve the ability to synchronize TDM clocks in terminal devices to the PSTN (or other) clock reference even though the intervening packet network is not synchronous. Any required timing synchronization information must be transported over the asynchronous data network. Clock synchronization across asynchronous packet data networks is described in I. Hadzic and E. S. Szurkowski, “High-Performance Synchronization for Circuit Emulation in an Ethernet MAN,” Journal of Communications and Networks, Vol. 7, No. 1, March 2005, as well as in U.S. patent application Ser. No. 10/260,790, filed on Sep. 30, 2002, as attorney docket no. Hadzic 3-28, the teachings of both of which are incorporated herein by reference.

Compared to circuit emulation, VoIP has simpler requirements for clock synchronization. When used to bypass the public network (for cost reduction), VoIP gateways at either end of the path are interfaced to the PSTN, and derive their timing via those connections. These gateways require only buffer management to cope with delays and delay variations (jitter) in the packet network.

Synchronization becomes more difficult when the source of a VoIP stream is disconnected from the PSTN (e.g., PBX with only a VoIP connection to the PSTN). The PBX can use a local clock that is not locked to a PSTN reference (although the synchronization techniques used for circuit emulation could be applied). Without synchronization, timing slips and data losses are inevitable, but the effects might not be noticeable to most users.

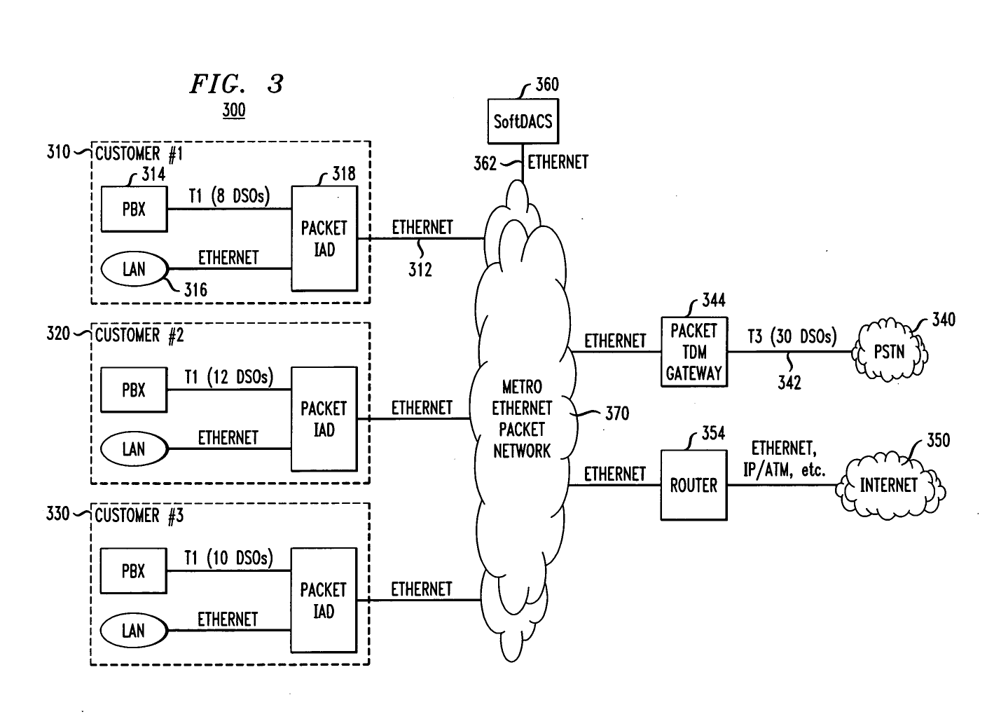

FIG. 3 shows a high-level block diagram of an exemplary, hybrid, packet-oriented communications network 300 using circuit emulation on Ethernet transport media to support communications between five end nodes (i.e., customers 310-330, PSTN 340, and Internet 350), according to one embodiment of the present invention. To support these communications, metro Ethernet packet network 370 is connected via one or more Ethernet links 362 to SoftDACS 360, a software-based cross-connect that emulates the hardware-based, circuit-oriented switching of DACS 160 of FIG. 1.

As in FIG. 1, each of customers 310-330 has a local voice-based network (e.g., PBX 314 of customer 310) and a local data-based network (e.g., LAN 316 of customer 310). Within each customer, a packet-based integrated access device (IAD) (e.g., packet IAD 318 of customer 310) functions as a mux/demux to interconnect the DS0 voice channels of the local voice-based network and the (e.g., Ethernet) data channels of the local data-based network with the corresponding Ethernet link (e.g., Ethernet link 312 for customer 310). Similarly, packet TDM gateway 344 interconnects PSTN 340 with metro Ethernet packet network 370, and router 354 interconnects Internet 350 with network 370. Note that the packet IAD in each customer and packet TDM gateway 344 convert between the circuit-based signals of the corresponding T1 or T3 link and the packet-based signals of metro network 370.

SoftDACS 360, a network element analogous to a TDM DACS 160 of FIG. 1, supports grooming for integrated voice+data services. SoftDACS 360 provides the same DS0 grooming capability as TDM DACS 160, but operates on the voice/data packets used to emulate TDM facilities, rather than directly on synchronous TDM lines.

Packet IADs at customer locations (e.g., packet IAD 318 of customer 310) convert T1s carrying voice traffic from PBXs (e.g., PBX 314) into packets, along with any required clock synchronization information. These circuit-emulation packets are addressed to SoftDACS 360. The Packet IAD multiplexes data packets from the enterprise LAN (e.g., LAN 316) with the (higher-priority) circuit-emulation packets onto a single connection to the Ethernet network.

The circuit-emulation packets are transported over metro Ethernet packet network 370 to SoftDACS 360. SoftDACS 360 grooms the DS0s in the incoming emulated TDM facilities from customers into new outgoing emulated TDM facilities connected (e.g., via gateway 344) to PSTN 340. This grooming assures efficient use of the TDM interface (e.g., T3 342) to the PSTN. In addition, SoftDACS 360 can also groom DS0s between emulated customer facilities to enable point-to-point connections for private circuits.

In another application, a wireless operator may use a (cheaper) Ethernet connection instead of a T1/E1 connection to connect its base station sites to the RNC site. Rather than replace legacy base stations with T1 interfaces with the ones that have native Ethernet interfaces, wireless operators may prefer to augment the base station site with the circuit emulation service (CES) interworking function (IWF) and use circuit emulation to transport T1/E1 payloads from the base station to the RNC site. At the RNC site, the packet flow may be converted back to T1/E1 circuits (using CES IWF) and terminated on a DACS or further optimization may be taken by terminating the CES packet flow on a SoftDACS.

SoftDACS 360 manipulates circuit-emulation packets and their contents. This can be (but does not have to be) in software rather than the relatively expensive hardware used for TDM slot manipulation in traditional DACS 160 of FIG. 1.

In one implementation of network 300, only packets involved in circuit emulation are addressed to SoftDACS 360. As such, data packets from the enterprise LANs can be routed by Ethernet network 370 without having to rely on SoftDACS 360. Note that, if necessary, circuit emulation can be used to transport data, as well as voice, e.g., when existing data equipment does not have a packet-oriented interface such as an Ethernet port.

In network 300 of FIG. 3, with a standalone PSTN gateway 344, there is no strict requirement for a clock in SoftDACS 360 to be synchronized with any other device in the network. The clocks in the customer's packet IADs could directly synchronize with the PSTN gateway, whose clock is derived from its connection to the PSTN. In this situation, SoftDACS 360 copies the packet timestamps, but otherwise appears as just a delay-and-jitter element to the synchronization algorithm in the endpoints.

In other network architectures, the SoftDACS could provide the reference clock for the customer premises equipment (TDM IADs). This would be useful if there was no connection to the PSTN from which the customer endpoints could derive timing, or if the VoIP gateway was incapable of supporting synchronization. In some cases, the SoftDACS may have a direct connection to a highly accurate and stable timing reference or clock.

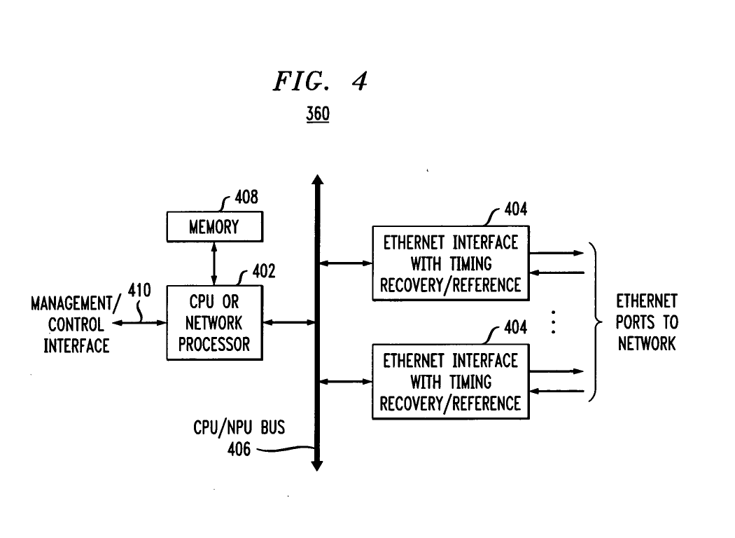

FIG. 4 shows a high-level block diagram of SoftDACS 360 of FIG. 3. SoftDACS 360 has a CPU or network processor 402 and one or more Ethernet interfaces 404 interconnected via bus 406. Each interface 404 connects SoftDACS 360 to the metro Ethernet infrastructure of network 370 of FIG. 3 via one or more Ethernet links 362.

In particular, each interface 404 receives incoming Ethernet packets from metro network 370 that have been addressed to SoftDACS 360 and places the incoming Ethernet packets from the emulated facilities in interface memory (not shown) that is accessible to processor 402. Each incoming Ethernet packet was generated by a particular source node (e.g., one of customers 310-330 or packet TDM gateway 344) and contains one or more T1 frames, each of which is destined for a particular destination node, where a given incoming Ethernet packet can contain T1 frames destined for one or more different destination nodes. Processor 402 operates on the incoming Ethernet packets stored in the memories of the various interfaces to extract and re-group the T1 frames of those packets to generate and store outgoing Ethernet packets in appropriate interface memories, where each outgoing Ethernet packet contains one or more T1 frames destined for a single destination node. Each interface 404 retrieves an outgoing Ethernet packet from its memory and transmits it via Ethernet link 362 and metro network 370 towards its destination node. The timing synchronization capability, in conjunction with appropriate buffering, allows incoming Ethernet packets from the various emulated facilities to all be ready for cross-connect processing at fixed intervals (e.g., integer multiples of 125 msec, the duration of a T1 frame).

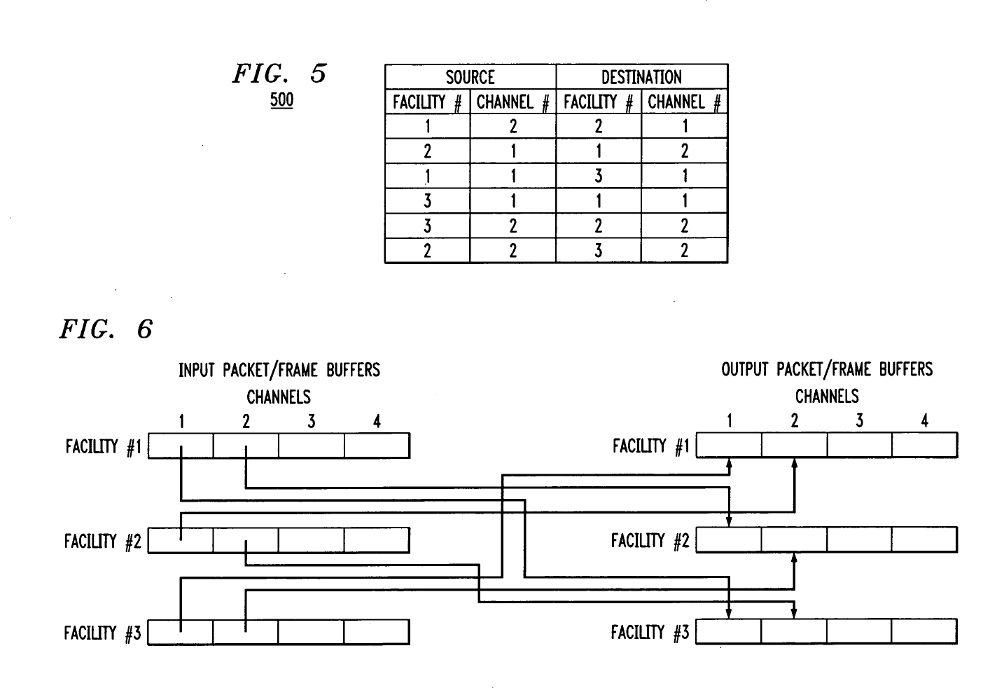

FIG. 5 shows an exemplary connection table 500 stored in memory 408 of FIG. 4 and accessed by processor 402 to convert incoming Ethernet packets into outgoing Ethernet packets. In particular, connection table 500 defines the emulated connections between the various sources and destinations of network 300 of FIG. 3, where each facility corresponds to an emulated T1/T3 link, and each channel corresponds to an emulated DS0 of that facility. Driven by the contents of connection table 500, processor 402 copies the DS0 slot contents from incoming packet buffers in interface memories to particular locations in outgoing packet buffers in appropriate interface memories, as represented in FIG. 6. To preserve the relationship amongst the timeslots (DS0) and thus fully emulate the TDM DACS, the switching process may keep track of incoming packet sequence numbers. Suppose, for example, that two packet flows are being combined into one TDM interface (e.g., one packet flow carries half of the time slots for said TDM interface, while the other packet flow carries the remaining timeslots). Typically, for any two packets that are to be combined into the TDM payload, the difference between their sequence numbers is held constant throughout the lifetime of the connection. The difference changes only if a packet has been lost or delivered out of order. For out-of-order delivery, re-ordering logic can be easily incorporated into the implementation. If the packet loss is left unhandled, then the time slots will be introduced, which may or may not be acceptable depending on the application. If the skew is not acceptable, timeslots corresponding to the lost packet can be replaced with dummy data, turning data loss into data corruption but preserving the time relationship amongst the good data in the ITDM interface. Once this assembly process is complete, processor 402 signals the Ethernet interfaces to transmit the outgoing Ethernet packets at the appropriate time.

As shown in FIG. 4, the contents of connection table 500 are set via supervision and management port(s) 410 on SoftDACS 360. These ports also allow various control commands to be issued to the device and allow alarms and statistics to be reported. These ports could support several different access methods, including command-line interface (CLI), Web browsers, SNMP, etc.

SoftDACS 360 enables customers having existing circuit-based, synchronous equipment (such as customers 310-330 of FIG. 3 having PBXs) to communicate both voice and data signals via a single, packet-based, asynchronous core network (such as metro Ethernet packet network 370) with each other and with conventional PSTN and Ethernet networks, without having to replace their existing equipment all at once with fully packet-based equipment.

It should be observed that some switching functionality can be achieved without the SoftDACS or any DACS in the network whatsoever by using structure-aware circuit emulation that (at the transmit side) maps subsets of TDM links to different packet flows and sends said packet flows to different destinations, while (at the receive side) combining other packet flows into new TDM interfaces. Since structure-aware CES is deemed more complex than structure-agnostic CES, SoftDACS advantageously provides the ability to perform this function while still using structure-agnostic CES.

Although the present invention has been described in the context of an Ethernet network, the present invention can also be implemented in the context of packet-based networks that conform to standards other than an Ethernet standard.

Although the present invention has been described in the context of emulated T1 frames, the invention can be implemented in other contexts, such as emulated frames of any suitable TDM link defined in ITU's SDH/PDH hierarchy.

The present invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A cross-connect for a packet-based network comprising more than two end nodes, the cross-connect comprising:
at least one interface adapted to receive incoming packets transmitted from one or more source nodes via the packet-based network to the cross-connect, each incoming frame containing a plurality of frames of emulated circuit-based payload data, each frame destined for a destination node; and
a processor adapted to extract the frames from the incoming packets and generate outgoing packets for transmission from the cross-connect via the packet-based network to one or more destination nodes, each outgoing packet containing a plurality of frames of emulated circuit-based payload data destined for a destination node.

2. The invention of claim 1, wherein:
the packet-based network is an Ethernet network;
the incoming and outgoing packets are Ethernet packets; and
the frames of emulated circuit-based payload data are emulated frames of a TDM link defined in ITU's SDH/PDH hierarchy.

3. The invention of claim 1, wherein, to convert the incoming packets into the outgoing packets, the processor uses a connection table that maps each frame of each packet from its source node to its destination node.

4. The invention of claim 3, wherein the connection table is stored in memory, and the processor converts the incoming packets into the outgoing packets using software-based processing.

5. The invention of claim 1, wherein:
the at least one interface is adapted to receive a first incoming packet from a first source node, wherein the first incoming packet contains at least one frame for a first destination node and at least one frame for a second destination node; and
the processor is adapted to extract the frames from the first incoming packet and generate a first outgoing packet containing the at least one frame for the first destination node and a second outgoing packet containing the at least one frame for the second destination node.

6. The invention of claim 1, wherein:
the at least one interface is adapted to receive a first incoming packet from a first source node and a second incoming packet from a second source node, wherein the first incoming packet contains at least one frame for a first destination node and the second incoming packet contains at least one frame for the first destination node; and
the processor is adapted to extract the frames from the first and second incoming frames and generate a first outgoing packet containing frames for the first destination node, where the first outgoing packet contains the at least one frame from the first source node and the at least one frame from the second source node.

7. The invention of claim 1, wherein:
the at least one interface is adapted to receive a first incoming packet from a first source node and a second incoming packet from a second source node, wherein:
the first incoming packet contains at least one frame for a first destination node and at least one frame for a second destination node; and
the second incoming packet contains at least one frame for the first destination node and at least one frame for the second destination node; and
the processor is adapted to extract the frames from the first and second incoming packets and generate a first outgoing packet containing frames for the first destination node and a second outgoing packet containing frames for the second destination node, wherein:
the first outgoing packet contains the at least one frame from the first source node for the first destination node and the at least one frame from the second source node for the first destination node; and
the second outgoing packet contains the at least one frame from the first source node for the second destination node and the at least one frame from the second source node for the second destination node.

8. The invention of claim 7, wherein:
the packet-based network is an Ethernet network;
the incoming and outgoing packets are Ethernet packets;
the frames of emulated circuit-based payload data are emulated frames of a TDM link defined in ITU's SDH/PDH hierarchy; and
to convert the incoming packets into the outgoing packets, the processor performs software-based processing using a stored connection table that maps each frame of each packet from its source node to its destination node.

9. The invention of claim 1, wherein the cross-connect provides a timeslot interchange function.

10. A packet network connected to more than two end nodes, the packet network having a cross-connect comprising:
at least one interface adapted to receive incoming packets transmitted from one or more source nodes via the packet-based network to the cross-connect, each incoming frame containing a plurality of frames of emulated circuit-based payload data, each frame destined for a destination node; and
a processor adapted to extract the frames from the incoming packets and generate outgoing packets for transmission from the cross-connect via the packet-based network to one or more destination nodes, each outgoing packet containing a plurality of frames of emulated circuit-based payload data destined for a destination node.

11. The invention of claim 10, wherein:
the packet-based network is an Ethernet network;
the incoming and outgoing packets are Ethernet packets; and
the frames of emulated circuit-based payload data are emulated frames of a TDM link defined in ITU's SDH/PDH hierarchy.

12. The invention of claim 10, wherein, to convert the incoming packets into the outgoing packets, the processor uses a connection table that maps each frame of each packet from its source node to its destination node.

13. The invention of claim 12, wherein the connection table is stored in memory, and the processor converts the incoming packets into the outgoing packets using software-based processing.

14. The invention of claim 10, wherein:
the at least one interface is adapted to receive a first incoming packet from a first source node, wherein the first incoming packet contains at least one frame for a first destination node and at least one frame for a second destination node; and
the processor is adapted to extract the frames from the first incoming packet and generate a first outgoing packet containing the at least one frame for the first destination node and a second outgoing packet containing the at least one frame for the second destination node.

15. The invention of claim 10, wherein:
the at least one interface is adapted to receive a first incoming packet from a first source node and a second incoming packet from a second source node, wherein the first incoming packet contains at least one frame for a first destination node and the second incoming packet contains at least one frame for the first destination node; and
the processor is adapted to extract the frames from the first and second incoming frames and generate a first outgoing packet containing frames for the first destination node, where the first outgoing packet contains the at least one frame from the first source node and the at least one frame from the second source node.

16. The invention of claim 10, wherein:
the at least one interface is adapted to receive a first incoming packet from a first source node and a second incoming packet from a second source node, wherein:
the first incoming packet contains at least one frame for a first destination node and at least one frame for a second destination node; and
the second incoming packet contains at least one frame for the first destination node and at least one frame for the second destination node; and
the processor is adapted to extract the frames from the first and second incoming packets and generate a first outgoing packet containing frames for the first destination node and a second outgoing packet containing frames for the second destination node, wherein:
the first outgoing packet contains the at least one frame from the first source node for the first destination node and the at least one frame from the second source node for the first destination node; and
the second outgoing packet contains the at least one frame from the first source node for the second destination node and the at least one frame from the second source node for the second destination node.

17. The invention of claim 16, wherein:
the packet-based network is an Ethernet network;
the incoming and outgoing packets are Ethernet packets;
the frames of emulated circuit-based payload data are emulated frames of a TDM link defined in ITU's SDH/PDH hierarchy; and
to convert the incoming packets into the outgoing packets, the processor performs software-based processing using a stored connection table that maps each frame of each packet from its source node to its destination node.

18. The invention of claim 10, wherein the cross-connect provides a timeslot interchange function.
